(19) United States
(12) Patent Application Publication
(10) Pub. No.: US 2004/0122746 A1
(43) Pub. Date: Jun. 24, 2004

(54) Method and system for direct purchase in response to a multi-media display

(76) Inventors: Michael L. Charlier, Palatine, IL (US); Thomas Schirtzinger, Woodstock, IL (US); Steve Bunch, Harvard, IL (US)

Correspondence Address: VEDDER PRICE KAUFMAN & KAMMHOLZ, 222 N. LASALLE STREET, CHICAGO, IL, 60601, US

(21) Appl. No.: 10/328,448

(22) Filed: Dec. 23, 2002

(51) Int. Cl. G06F 17/60

(52) U.S. Cl. 705/27

(57) ABSTRACT

A method and system for direct purchase in response to a multi-media display includes receiving a streaming multi-media signal (104) with a streaming video receiver (102), wherein the streaming multi-media signal (104) has a plurality of objects (112). The system and method also includes associating at least one object identifier (124) with at least one of the plurality of objects (112), wherein the object identifiers (112) are encoded within the multi-media signal (104), but may also be retrievable from a proprietary network (132). Also included are displaying the objects (140) on a screen (138) and receiving an object selection signal (114) from a remote device (116) to provide a selection of at least one of the plurality of objects (112). Thereby providing the option for an end user to engage in a direct purchase of the selected object (112), typically from a point of sale server (126).

### BACKGROUND OF THE INVENTION

The present invention relates generally to providing point of sale purchasing options and more specifically to providing a point of sale purchasing option in conjunction with a multi-media display.

With higher processing requirements, there exists a trend to provide for improved compression techniques for multi-media information. One proposed solution to improving data compression involves compressing data based on objects within multiple frames. Previously, compression techniques included transmitting a beginning frame and an ending frame and generating the intermediate frames based on a vector analysis of the projected movement of the objects within the frames.

As compression may be based on objects within the frame, there concurrently exists the ability to associate specific information about a particular object within the compressed data. The MPEG-4 standard developed by the Moving Pictures Expert Group provides for the ability to insert object specific information within a multi-media display.

Within the defined standard, a delivery multimedia integration framework (DMIF) provides for a session protocol for the management of multi-media over any suitable transmission. Based on, among other things, a quality of service consideration, the integration framework of the DMIF works with all three major technologies, interactive network technologies, broadcast technologies and memory-based technologies. Wherein, interactive network technologies include, among other things, the Internet, broadcast technology includes, among other things, cable and satellite transmission, and memory-based technologies includes, among other things, optical disks such as a digital versatile disc (DVD). The compression technique allows for platform-independent data transmission, so the compressed data may be transmitted across a digital communication link, such as a digital cable connection, a satellite cable transmission, and internet transmission and the data is further capable of being stored within any suitable memory device.

With the ability to create an object-based compression system, there exists other opportunities for embedding information associated with the particular objects. While intellectual property right holders may be able to embed proprietary information, there also exists the ability to embed commercial information.

Another area of development is the merging of point of sale transactions and providing a seamless buying experience for an end user in utilizing current data transmission techniques in all various levels of electronic commerce. With the increase in transmission of information, there is also the potential for an increase in advertising and commercial information to end users. Using the Internet as an example, Internet search engines sometimes target advertisement banners or pop-up windows based on Internet search terms, wherein a company may have a contractual right for direct advertisement when a particular search term is entered.

### BRIEF DESCRIPTION OF THE DRAWINGS

The invention will be more readily understood with reference to the following drawings wherein:

FIG. 1 illustrates an example of a system for direct purchase in response to a multi-media display;

FIG. 2 illustrates another example of the system for direct purchase in response to a multi-media display;

FIG. 3 illustrates an example of the steps of a method for providing a direct purchase in response to a multi-media display;

FIG. 4 illustrates the steps of another example of the method for providing a direct purchase in response to a multi-media display;

FIG. 5 illustrates the steps of an example of one embodiment of the method for providing a direct purchase in response to a multi-media display; and

FIG. 6 illustrates the steps on an example of another embodiment of the method for providing direct purchase in response to a multi-media display.

### DETAILED DESCRIPTION OF THE INVENTION

Briefly, a method and system for direct purchase in response to a multi-media display includes receiving a streaming multi-media signal with a streaming video receiver, wherein the streaming multi-media signal has a plurality of objects. A direct purchase includes accessing a point of sale location, such as a website or other form of interactive location for providing for the facilitation of a purchase, whether the purchase be immediate, such as one-click purchase, or delayed, such as loading information into memory for later access, for example, a grocery or wish list. The system and method also includes associating at least one object identifier with at least one of the plurality of objects, wherein the object identifiers are encoded within the multi-media signal, but may also be retrievable from a proprietary network.

The system and method further includes displaying the objects on a screen and receiving an object selection signal from a remote device such that the object selection signal provides an indication of a selection of at least one of the plurality of objects. As such, the method and system provides the option for an end user to engage in a direct purchase of the selected object, typically from a point of sale server.

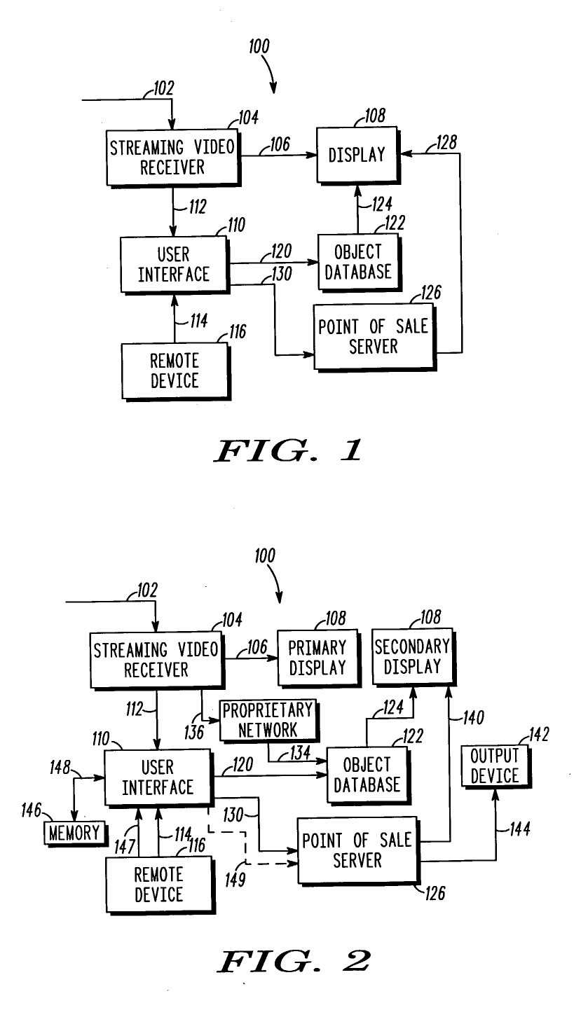

More specifically, FIG. 1 illustrates a system 100 for direct purchase in response to a multi-media display. A streaming video receiver 102 receives a streaming video signal 104. The streaming video receiver 102 includes any suitable receiver capable of receiving a streaming multi-media signal. As recognized by one having ordinary skill in the art, streaming multi-media signal may be any signal having multiple medias, such as video and audio, disposed within a continuous stream of video input, which may be provided from a live video source, from a memory source, from a processor or any other suitable source. The streaming video receiver 102 provides a display signal 106 to a display 108, wherein the display signal 106 includes the frames of video and accompanying audio and other media information for the multi-media display 108.

The system 100 further includes a user interface 110, which may be implemented in hardware, software, or a combination thereof. The user interface 110 receives an object based signal 112 from the streaming video receiver 102, representing the selectable objects. The user interface 110 is also capable of receiving an object selection signal 114 from a remote device 116. The user interface 110 provides an interface between the objects of the multi-media display and the object selection signal 114. In one embodiment, the remote device 116 generates the object selection signal 114 based on the display 108, therefore the user interface 110 must be able to coordinate object selection with the current multi-media display. Moreover, the remote device may be an electronic writing device, such as an electronic writing described in copending U.S. patent application Ser. No. ______, entitled “SYSTEM AND METHOD FOR INTERACTION BETWEEN AN ELECTRONIC WRITING DEVICE AND A WIRELESS DEVICE,” having a filing date of ______, 2002.

When an object has been selected, the user interface 110 provides an object signal 120 to an object database 122. The object database 122 may be any suitable memory device having information about the specific object stored therein. For example, if the selected object is a particular electronic product, the object database may contain information on the manufacturer, quality ratings, pricing information, shipping information, or any other suitable information for use in a direct purchase. In response to the object signal 120, the associated product information is extracted from the object database 122.

In order to provide a direct visual feedback, an object information display signal 124 is provided to the display 108. In one embodiment, the display 108 may provide for a picture-in-picture display to allow for the continued display of the multi-media display signal 106 while displaying the object information display signal 124. In another embodiment, the display 108 may be provided to a memory, such as available in a personal video recorder, thereby pausing the streaming video 104 while the object information display signal 124 is displayed. Furthermore, as discussed below with regards to FIG. 2, different displays may be provided for displaying the different information.

Regardless thereof, an end user may, through the remote device 116, select a particular object and view a visual display of product information related to the product. To facilitate a direct purchase, the user interface provides a direct interface with a point of sale server 126. The point of sale server 126 may be a commercial website for the manufacturer of the product, a general commercial website that sells the particular object, may be a direct website corresponding to a relation with a service provider who provides the incoming multi-media stream 104, or any other suitable readily accessible commercial and/or retail server as recognized by one having ordinary skill in the art.

The point of sale server 126 may provide further product or shipping information 128 to the display 108. Although, the remote device 116 allows an end user to engage in a direct purchase of the product by having the user interface generate a server signal 130, which may be a confirmation signal to authorize the purchase, may be a request for more information, may be a request to place the order on hold, may be a request to add the product to an electronic list, such as a wish list, a wedding registry, grocery list, or any other electronic catalog of items.

Therein, the system 100 allows for a direct purchase of a selected object in response to a multi-media display. In one embodiment, the user may need to selectively engage the streaming video receiver 102 to enter a direct purchase mode or may be readily available for any objects having product information associated therewith. Furthermore, in another embodiment, the display 108 may provide for a visual indicator of objects having the ability to be selected and subject to a direct purchase, such as providing a list in an offset portion of the display, providing an illumination around the perimeter of the object, highlighting the object, or any other suitable identifier as recognized by one having ordinary skill in the art.

FIG. 2 illustrates another embodiment of the system 100 including the streaming video receiver 102 that receives the incoming video stream 104. The system includes the display 108, designated herein as the primary display 108 as the display 108 provides sole display for the multi-media display. The streaming video receiver 102 is also coupled to the user interface 110 and receives the object selection signal 114 from the remote device 116.

The system 100 of FIG. 2 further includes a proprietary network 132 which may be any type of network capable of being accessed and providing object information 134 to the object database 122. The proprietary network 132 may receive a multi-media file signal 136, which indicates the object information 134 to be provided to the object database 122. For example, in one embodiment, multi-media information stored on an optical disc may become outdated, therefore it may be beneficial to provide the proprietary network 132 for updating the product information every time the file is accessed. In another example, a manufacturer may offer DVDs at a reduced price or free of charge and provide for the association of their own product information, so the object information 134 is extracted from the manufacturer's proprietary network 132.

The system 100 of FIG. 2 operates similar to the system of FIG. 1, but further illustrates a secondary display 138 that receives a secondary display signal 140 from the point of sale server 126. In one embodiment, the secondary display may be the picture-in-picture format as discussed above, but may also include a separate and distinct display, such as a second monitor, a tablet computer, a personal digital assistant or any other suitable display for providing a visual representation of the corresponding object information 124.

The system 100 further includes an output device 142 which is capable of receiving a product signal 144 from the point of sale server 126. The output device 142 may be a storage device, a printer, a wireless device, such as a personal digital assistant, or any other suitable output device 142. If the output device 142 is a memory, the memory may store the name of the product for an electronic list, such as a grocery list, a holiday wish list, a birthday list or any other type of catalog of items. Furthermore the output device may further facilitate other requirements for a point of sale transaction, such as, but not limited to, providing a place to store or print a receipt, a rebate form, warranty information, sale terms and conditions and customer feedback forms.

To also assist in streamlining the direct purchase process, the system 100 includes a memory 146 operably coupled to the user interface 110. At any given point in time, a user may enter payment and shipping information 148, wherein the shipping information includes, but not limited to, a checking account number, a credit card number, a credit account with particular retailers, and credit accounts with online electronic commerce companies. The memory 146 is further capable of storing the shipping information 148, such as an address. During the direct purchase, when an item has been chosen, the user interface may retrieve the payment information and/or shipping information 148 from the memory 146. In another embodiment, the user interface 110 may store the shipping information and payment information 148 from a previous transaction and provide the user an option to re-use old information. As recognized by one having ordinary skill in the art, the memory 146 may be disposed at any location within the system 100 such that the payment and/or shipping information 148 may be provided to the point of sale server 126 to facilitate the direct purchase.

In another embodiment, the remote device 116 may be utilized to provide a validation signal 147 to the user interface 110. A validation signal 147 may be any suitable type of validation, such as, but not limited to, entering a personal identification number, entering a password, entering a signature, providing a fingerprint recognition or other distinct moving of the remote device 116 or any other recognized validation signal 147 such that the end user may validate the transaction. In this embodiment, the user interface 110 may further provide an authorization acknowledgement 149 to the point of sale server 126. As recognized by one having ordinary skill in the art, the authorization acknowledgement 149 may be the PIN, the password, the signature, an acknowledgement signal signifying authorization or any other suitable output. Furthermore, the point of sale server 126 may exchange information with the user interface 110 to further facilitate the authorization acknowledgement 149, such as an encryption key.

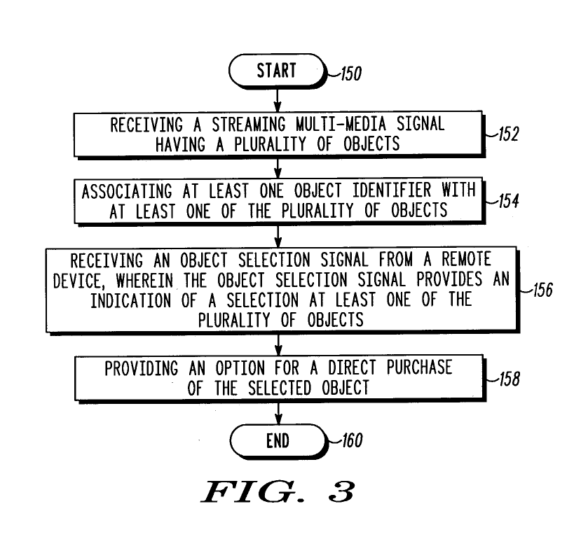

FIG. 3 illustrates a flow chart representing the steps of a method for direct purchase in response to a multi-media display. The method begins, step 150, by receiving a streaming multi-media signal having a plurality of objects, step 152. As discussed above, the streaming multi-media signal 104 is received by the streaming video receiver 102 and is encoded to provide for object-based encoding, such as MPEG-4 encoding. The next step is associating at least one object identifier with at least one of the plurality of objects, step 154. Through the user interface 110 and operation of the remote device 116, an object may be selected to provide further product information thereon.

The next step, step 156, includes receiving an object selection signal from a remote device, wherein the object selection signal provides an indication of a selection of at least one of the plurality of objects. In one embodiment, the object selection signal may be generated by an electronic writing device having a cursor corresponding to the display 108 and keystrokes using the electronic writing device may translate into the object selection signal 114. Thereupon, the method includes providing an option for a direct purchase of the selected object, step 158. In one embodiment, a display screen, such as 138, may provide a window asking a user if the user wishes to purchase the item and a box for clicking yes to accept the terms and conditions and submit the payment information 148 stored in the memory 146. As such, the method is complete.

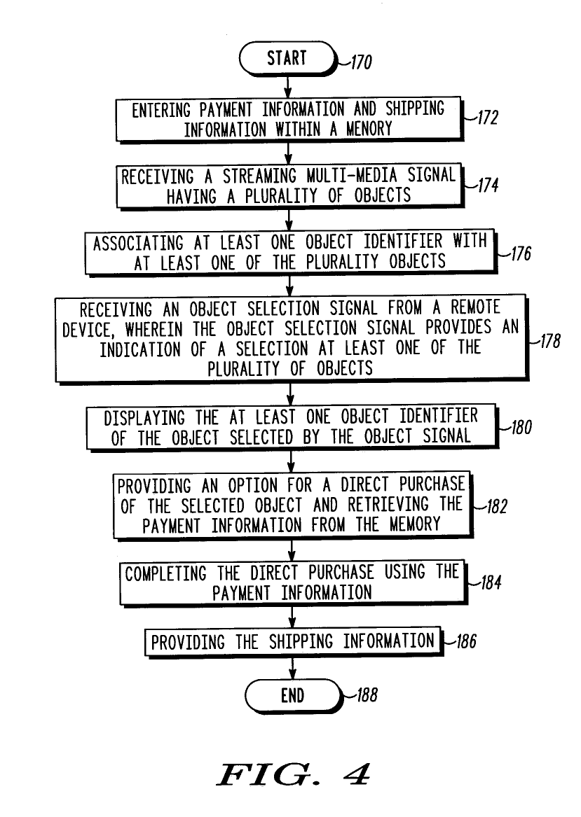

FIG. 4 illustrates the steps of a flowchart of another example of the method for direct purchase in response to a multi-media display. The method begins, step 170, by entering payment information and shipping information within a memory 172. Similar to the system 100 of FIG. 2, the payment and shipping information 148 may be stored within the memory 146. The next step is receiving a streaming multi-media signal having a plurality of objects, step 174, similar to step 152 of FIG. 3.

Therein, the method includes associating at least one object identifier with at least one of the plurality of objects, step 176, similar to step 154 of FIG. 3. The next step, step 178, is receiving an object selection signal from a remote device, wherein the object selection signal provides an indication of a selection of at least one of the plurality of objects, similar to step 156 of FIG. 3. Thereupon, at least one object identifier of the object selected by the object signal is displayed, step 180. In one embodiment, the object identifier, as referred to as product information for a direct purchase, 140, is displayed on the display 138.

The next step is providing an option for a direct purchase of the selected object and retrieving the payment information from memory, step 182, similar to step 158 of FIG. 3. As such, the direct purchase may be completed using the payment information, step 184 and the shipping information may also be provided, step 186. As discussed above, this information 148 may be retrieved from the memory 146, but may also be referenced in other embodiments, such as having an account identification number for a commercial server and instead of providing payment and shipping information 148, the account information is provided, thereby automatically using previously stored payment information and shipping to a stored address. Thereupon, the method is complete 188.

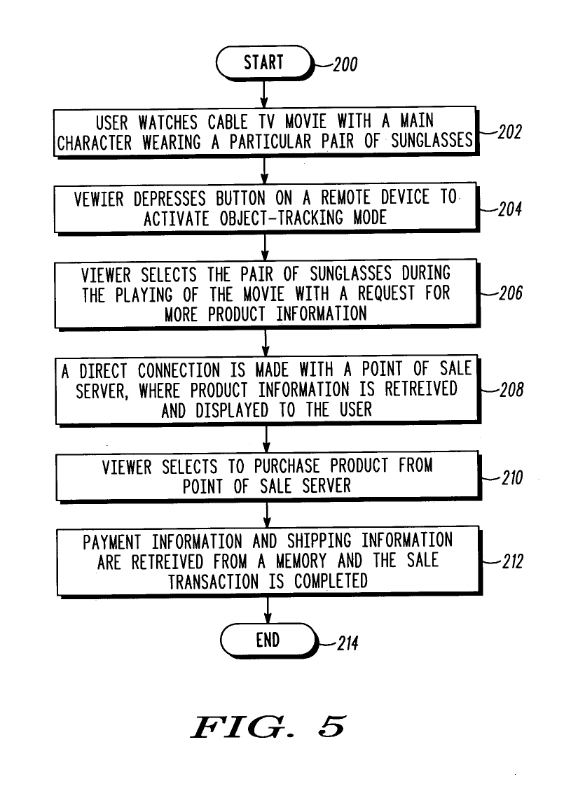

FIG. 5 illustrates the steps of a flow chart of an example of a system using the method for direct purchase in response to a multi-media signal. The method begins 200, when a user watches a cable television movie having a lead character with a particular pair of sunglasses, step 202. As the multi-media signal has object-based encoding, the viewer may depress a button on a remote device to activate an object-tracking mode, step 204. While in this mode, the viewer may select the pair of sunglasses during the playing of movie, wherein the viewer provides a request for more information on the sunglasses, step 206. Therein, a direct connection is made with a point of sale server, where product information relevant to the sunglasses, such as the sunglasses, sunglass cases, optometrists who prescribe prescription sunglasses, or related information for sale, is retrieved and displayed to the user, step 208.

The viewer may then select to purchase the any of the offered products from the point of sale server, such as an official movie web site operated by the creator of the movie, a popular online retailer, a cable service provide, or any other electronic retailer capable of engaging in the electronic commerce, step 210. The next step, step 212, includes retrieving payment information and shipping information from a memory and thus the sale transaction is completed. Thereupon, the method is complete 214.

As such, the system and method for direct purchase in response to a multi-media signal utilizes existing object-based encoding techniques to provide a further level of interactivity between a viewer and possible advertisers or retailers. The system and method also provides for opportunities for advertisers to subsidize the cost of creating a multi-media display by having product placement with associated product information therein. There also exists the ability for advertisers to subsidize the costs of multi-media files, such as DVDs by inserting product placements therein. For example, a large retailer may wish to give DVDs to customers for free based on a projected analysis that they can generate a profit through placing their product in the multi-media display and reasonably expect a certain percentage of users to direct purchase the object.

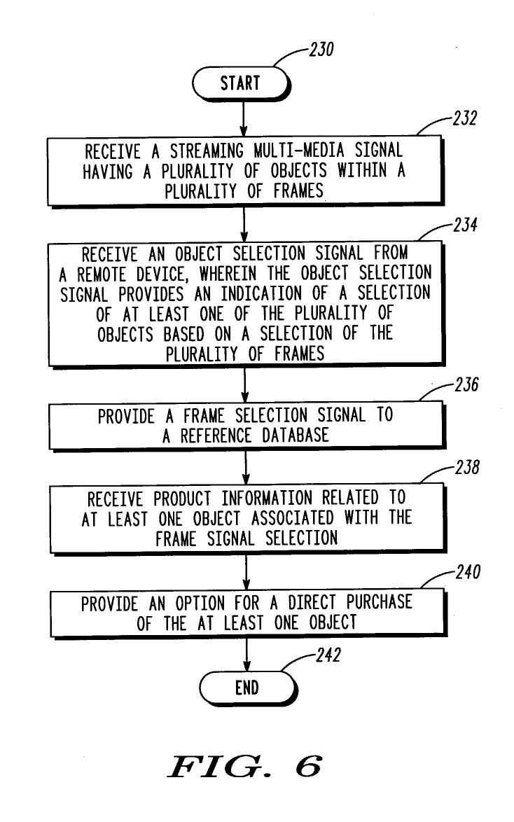

FIG. 6 illustrates another embodiment of a method for providing a direct purchase opportunity in response to a multi-media display. This embodiment utilizes an overlay technique which does not require the incoming streaming multi-media to have object information embedded therein, but rather the object information may be stored on a reference database, wherein the reference database may be any suitable type of storage location for storing product information. In one embodiment, the product information is stored within the reference database according to frame information associated with the streaming multi-media, but in another embodiment, the frame information may be provided to an intermediary server which utilizes a reference technique, such as a look up table, to then effectively access the reference database to extract associated product information.

The method begins, step 230, by receiving a streaming multi-media signal having a plurality of objects within a plurality of frames, step 232. For example, a streaming multi-media signal may be a television program that includes multiple frames of visual and audio data, wherein a display device, such as a television, displays each frame and during the display of each frame, objects are visible. In one example, a frame may include a person wearing a particular brand of clothing, drinking a particular beverage, holding a name-brand piece of sports equipment and billboards having direct advertising in the background.

The next step includes receiving an object selection signal from a remote device, wherein the object selection signal provides an indication of a selection of at least one of the plurality of objects based on a selection of one of the plurality of frames, step 234. In this embodiment, the remote device, such as the remote device 116 of FIG. 2 may be used to select an individual frame. In a further embodiment, the remote device 116 may be utilized to select a particular region of a frame, wherein the particular region may provide for an association with one or more objects displayed on the frame.

The next step, step 236, includes providing a frame selection signal to a reference database. As discussed above, the reference database contains product information. In one embodiment, the frame selection signal includes a time stamp and other associated information such that corresponding product information may be accessed from the reference database. Using the above example, an end user may select a frame having the character wearing the product and using the sports equipment. The frame selection signal may include the time stamp signifying the particular frame on a particular television channel from a particular service provider.

In another embodiment, the frame selection information may further include a position indicator that indicates which region of the display of the particular frame was selected. In one embodiment, the display, such as a television screen, may divided into segments, such as a grid, wherein the position indicator represents an associated grid segment representing position. In another embodiment, the cursor may have an associated position location in terms of vertical and horizontal coordinates, commonly referred to as X, Y coordinates, such that the position information may include coordinate information of the cursor on the display. In this overlay embodiment, the grid or cursor location within the position information may be independent of the display, such that any suitable display device may be utilized and the position information may be generated in conjunction with the display of the streaming multi-media or a particular frame, such as in a pause or freeze-frame condition. Using the position information, the reference database may provide product information associated with a specific product, whereas without the position information, product information for all products within the frame may be accessed.

Thereupon, step 238, the method includes receiving product information related to at least one of the objects disposed within the frame referenced by the frame selection signal. As discussed above, this selection information may be provided to the display 108 or to the second display 138 of FIG. 2. The product information provides the option for a direct purchase of at least one of the objects, step 240. As defined above, the direct purchase may be facilitated using the remote device 116 of FIG. 2 or any other suitable means for completing a point of sale transaction. As such, the method is complete, step 242.

It should be understood that there exists implementations of other variations and modifications of the invention and its various aspects, as may be readily apparent to those of ordinary skill in the art, and that the invention is not limited by the specific embodiments described herein. For example, remote device 116 and the secondary display 138 may be integrated into a single device, such as a PDA for allowing direct purchasing without interfering with the streaming multi-media display. It is therefore contemplated and covered by the present invention, any and all modifications, variations, or equivalence to fall within the spirit and scope of the basic underlying principals disclosed and claimed herein.

What is claimed is:

1. A method for direct purchase in response to a multi-media display, the method comprising:
receiving a streaming multi-media signal having a plurality of objects;
associating at least one object identifier with at least one of the plurality of objects;
receiving an object selection signal from a remote device, wherein the object selection signal provides an indication of a selection of at least one of the plurality of objects; and
providing an option for a direct purchase of the selected object.

2. The method of claim 1 further comprising:
prior to providing the option for the direct purchase of the selected object, displaying the at least one object identifier of the object selected by the object signal.

3. The method of claim 1 further comprising:
prior to receiving a streaming multi-media signal, entering payment information and shipping information within a memory; and
in response to the option for the direct purchase, retrieving the payment information from the memory.

4. The method of claim 3 further comprising:
receiving a validation signal; and
generating an authorization acknowledgement signal to verify authorization of the direct purchase.

5. The method of claim 1 wherein the streaming video is compressed within a moving pictures expert group (MPEG) level four compression.

6. The method of claim 1 wherein the streaming video is provided from a storage device.

7. The method of claim 1 wherein the streaming video is received by a set-top box.

8. The method of claim 1 wherein the direct purchase is from a commercial service provider.

9. The method of claim 1 further comprising:
embedding objects within the streaming video for providing the option of a direct purchase.

10. The method of claim 1 wherein the step of associating the at least one object identifier further comprises:
retrieving the object identifier information from a proprietary network.

11. A system for direct purchase in response to a multi-media display, the system comprising:
a multi-media receiver capable of receiving an incoming multi-media stream;
a display device coupled to the multi-media receiver such that the display device is capable of displaying the incoming multi-media stream;
a user interface operably coupleable to the multi-media receiver and the display device; and
a remote device in communication with the user interface such that the remote device may select an object within the incoming multi-media stream such that point of sale information regarding the object may be provided to the display device.

12. The system of claim 11 further comprising:
the user interface operably coupleable to a point of sale server such that a direct purchase may be performed.

13. The system of claim 11 further comprising:
a memory operably coupled to the user interface, wherein the memory is capable of storing payment information and shipping information such that the user interface may provide the payment information and shipping information to the point of sale server.

14. The system of claim 11 further comprising:
the user interface being operably coupleable to a proprietary network, wherein the proprietary network contains the point of sale information.

15. The system of claim 11 wherein the multi-media receiver is a television set-top box.

16. The system of claim 11 wherein the remote device is at least one of: an electronic writing device, a mouse, a joystick, a personal digital assistant, a tablet personal computer, a laptop computer, a desktop computer and a keyboard.

17. The system of claim 11 wherein the display device includes:
a primary display device coupled to the multi-media receiver such that the primary display device is capable of displaying the incoming multi-media stream; and
a second display device capable of receiving and displaying the point of sale information.

18. A method for direct purchase in response to a multi-media display, the method comprising:
receiving a streaming multi-media signal, wherein the streaming multi-media signal is decoded on an object basis, the multi-media signal having a plurality of objects embedded therein;
receiving at least one object identifier for each of the plurality of objects;
providing the streaming multi-media signal to a display;
providing an indicator of each of the plurality of objects having the at least one object identifier associated therewith;
receiving an object selection signal from a remote device, wherein the object selection signal provides an indication of a selection at least one of the plurality of objects; and
providing an option for a direct purchase of the selected object.

19. The method of claim 18 further comprising:
prior to receiving a streaming multi-media signal, entering at least one of payment information and shipping information within a memory; and
in response to the option for the direct purchase, retrieving the payment information from the memory.

20. The method of claim 19 further comprising:
completing the direct purchase using the payment information; and
providing the shipping information.

21. The method of claim 18 further comprising:
embedding objects within the streaming video for providing the option of a direct purchase.

22. The method of claim 18 wherein the step of associating the at least one object identifier further comprises:
retrieving the object identifier information from a proprietary network.

23. A method for direct purchase in response to a multi-media display, the method comprising:
receiving a streaming multi-media signal having a plurality of objects within a plurality of frames;
receiving an object selection signal from a remote device, wherein the object selection signal provides an indication of a selection of at least one of the plurality of objects based on a selection of one of the plurality of frames;
providing a frame selection signal to a reference database;
receiving product information related to at least one object associated with the frame associated with the frame selection signal; and
providing an option for a direct purchase of the at least one object.

24. The method of claim 23 wherein the frame selection signal includes a time stamp indicating the position of the frame with respect to the streaming multi-media signal.

25. The method of claim 23 wherein the object selection signal includes a position indicator, such that the position indicator may be included in the frame selection signal provided to the reference database.

26. The method of claim 25 wherein the position indicator may be used to reference one or more objects for possible direct purchase based on a proximity of the position indicator in the selected frame.

27. The method of claim 23 wherein the reference database may be a third-party database hosting the product information, such that product information may accessed based on the frame selection signal.
